(19) United States
(12) Patent Application Publication
(10) Pub. No.: US 2008/0144918 A1
(43) Pub. Date: Jun. 19, 2008

(54) SYSTEM AND METHOD FOR TUBE SCARF DETECTION

(76) Inventors: Kan Li, Toronto (CA); Tara MacDougall, Grimsby (CA); David Sloan, Hamilton (CA)

Correspondence Address: BLAKE, CASSELS & GRAYDON LLP, BOX 25, COMMERCE COURT WEST, 199 BAY STREET, SUITE 2800, TORONTO, ON, M5L 1A9, omitted

(21) Appl. No.: 11/859,101

(22) Filed: Sep. 21, 2007

Related U.S. Application Data
(60) Provisional application No. 60/826,418, filed on Sep. 21, 2006.

(51) Int. Cl. G06K 9/00

(52) U.S. Cl. 382/141; 348/86

(57) ABSTRACT

A system and method are provided for detecting extraneous material, often referred to as scarf, in the interior of a tubular steel product. The system is arranged to illuminate one end of the tube as it passes through the field of view of an imaging system, preferably a Smart Camera. The camera obtains images and processes the images to determine if scarf is present in the interior of the tube. Preferably a processor determines the percentage of dark pixels in the interior of the tube as detected in the image and if a predetermined threshold is met or exceeded, the tube fails. A blob sensor is also preferably used to avoid false positives where the dark pixels do not have a certain amount of connectivity.

This application claims priority from U.S. Application No. 60/826,418 filed on Sep. 21, 2006, the contents of which are incorporated herein by reference.

### FIELD OF THE INVENTION

The present invention relates generally to imaging systems and has particular utility in detecting extraneous material in tubular products.

### DESCRIPTION OF THE PRIOR ART

Tubular products, in particular steel tubes, are manufactured by forming a sheet of steel and welding the resulting seam, which creates a weld bead along such seam. Traditionally, the tube is then machined to remove any excess material from the weld bead on both the exterior and interior of the tube to smooth the inner and outer surfaces of the tube. The excess or extraneous material is commonly referred to in the steel making industry as “scarf”. Scarf can obstruct the interior of the tube and can pose a safety hazard as a result of sharp edges and points on the scarf. It is paramount that the customer does not receive a tube that contains any amount of scarf. Therefore, the scarf is removed before the tube is cut and loaded for shipping.

It is common in the steel making industry to use a blowout system to remove the scarf inside tubular products. The blowout system sends a high-pressure solution through the tubular product in an attempt to clear the scarf from the interior of the tube. In some cases, it has been found that a blowout system is ineffective up to 30% of the time. This has created the need for manual re-inspection of the tubes just prior to shipment. However, due to human error, the manual re-inspection is often ineffective and unsuccessful at preventing the presence of scarf in a shipped product. Moreover, in automated environments, it is generally undesirable to have a manual inspection clue to the increased labour required or the additional responsibilities required by an existing employee.

The failure of the blowout system therefore causes not only a safety concern but can also increase customer claims, increase the number of manual inspections with an inherent likelihood for human error, increased delays, damaged equipment and other negative impacts on yield.

It is therefore an object of the following to obviate or mitigate the above disadvantages.

### SUMMARY OF THE INVENTION

In one aspect, a method for detecting extraneous material in a tubular product is provided comprising illuminating the tubular product from one end; obtaining an image of the tubular product from the other end; and processing the image to determine the presence of the extraneous material in the interior of the tubular product.

In another aspect, a system for detecting extraneous material in a tubular product is provided comprising an illumination system for illuminating one end of the tubular product; an imaging system for obtaining an image of the tubular product from the other end; and a processing module for processing the image to determine the presence of the extraneous material in the interior of the tubular product.

### BRIEF DESCRIPTION OF THE DRAWINGS

An embodiment of the invention will now be described by way of example only with reference to the appended drawings wherein:

FIG. 1 is a schematic flow diagram showing stages in steel production including a scarf detection stage.

FIG. 2 is a perspective view of the detection stage of FIG. 1.

FIG. 3 shows a geometrical arrangement of the detection stage of FIG. 1.

FIG. 4 is an image of a tube containing scarf.

FIG. 5 is another image of a tube containing scarf.

FIG. 6 is a schematic diagram of an object find step in a tube inspection process.

FIG. 7 is a schematic diagram of a circle find step in a tube inspection process.

FIG. 8 is a schematic diagram of the application of an area sensor in a tube inspection process.

FIG. 9 is a schematic diagram of the application of a blob sensor in a tube inspection process.

FIG. 10 is a flow diagram illustrating steps in a tube inspection process.

FIG. 11 is a flow diagram illustrating steps in an inspection trigger routine for the tube inspection process of FIG. 10.

### DETAILED DESCRIPTION OF THE INVENTION

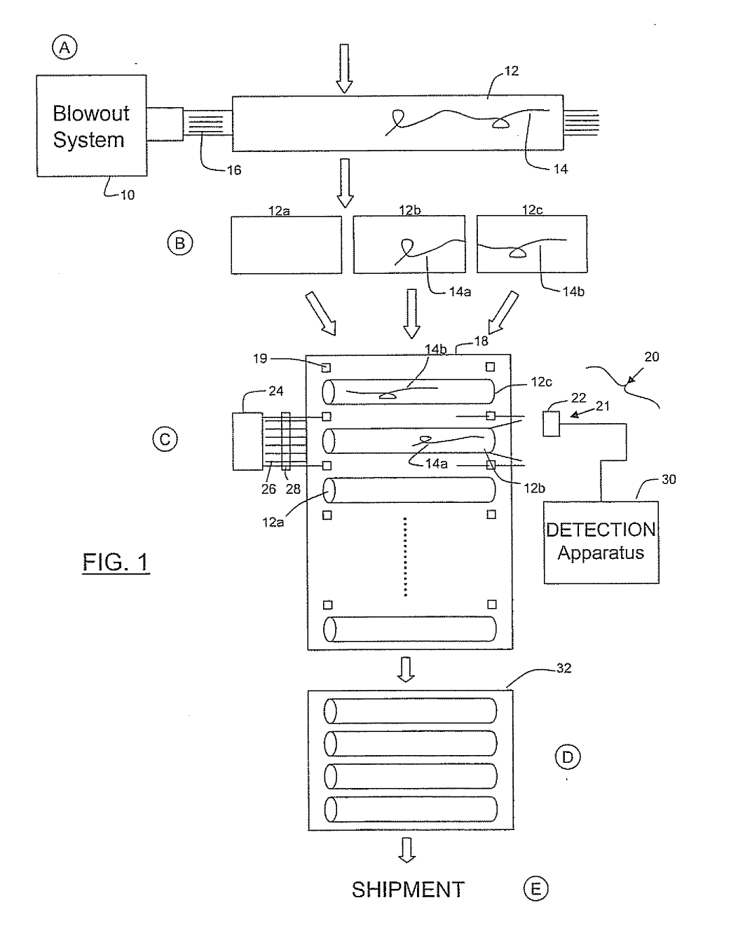

Referring therefore to FIG. 1, various stages in a tubular product making process are shown. In stage A, a blowout system 10 directs a stream of fluid 16 through a length of steel tube 12 to flush the tube 12 of a piece of extraneous material, commonly referred to in the steel making industry as scarf 14. As can be seen in FIG. 1, in this example, the blowout system 10 is unsuccessful at removing the scarf 14, and when the tube 12 is cut at stage B into three shorter lengths of tube, i.e. tubes 12a-c, a first portion of scarf 14a remains in tube 12b and another portion of scarf 14b remains in tube 12c.

Once the tubes 12 are cut, they proceed to a conveyor belt 18 with protruding tracks 19, which aligns the tubes 12 for loading at stage D into a shipping bin 32. The tubes 12 in the bin 32 are typically inspected prior to shipping at stage E. While the tubes 12 are being conveyed during stage C, a tube scarf detection system 20 captures images of the tubes 12 as they pass through the field of vision of an imaging system 21 comprising a camera 22, whilst being illuminated by an opposite band of light 26 generated by an illumination system 24. A scarf detection system 20 processes the images using detection apparatus 30 for inspecting the tubes 12.

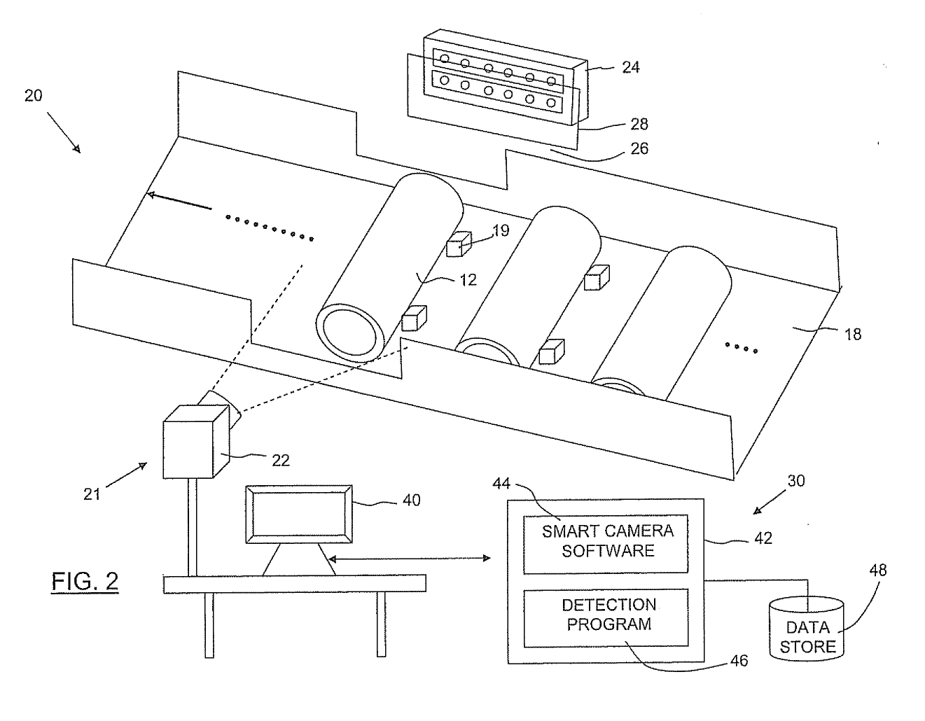

The scarf detection system 20 is shown in greater detail in FIG. 2. The imaging system 21 and illumination system 24 are arranged on opposite sides of the conveyor 18 and positioned such that a generally unobstructed view of the tube ends is obtained as they pass through the camera's field of view. The illumination system 24 preferably comprises a pair of stacked linear LED lights. Red light has been found to be preferred as it can be filtered out from ambient light and other lighting abnormalities, which are typically white. Suitable linear lights are those produced by Spectrum Illumination 1M. Linear LED light arrays are chosen where low maintenance and longevity are desired. For example, a Spectrum linear LED array often provides sufficient illumination for up to 100,000 hours. It will be appreciated that, where applicable, white spot lighting may also be used, however, the intensity of LED lights is preferred since it has been found to generally illuminate only the area(s) of interest in the image obtained by the imaging system 21.

Preferably, a sheet of diffuse glass 28 is placed in the vicinity of the illumination system 24 to spread the light 26 emitted to mitigate harsh light and hard shadows. The camera 22 is preferably a Smart Camera (e.g. a smart imaging DVT™ camera) which can extract information from images without the need for an external processing unit in order to make results of such processing available to the detection apparatus 30. As explained in greater detail below, the optics for the system 20 are chosen based on the environment and the geometrical constraints. For the following examples, it has been found that suitable camera settings comprise a 55 mm lens with a 3.43 mm aperture, and an f-stop of 1/16. The exposure time for the camera can affect which areas of the tube are illuminated in the image and typically an exposure time of under 20 ms, preferably around 8 ms can be used. In general, approximately one image per second or better can be obtained, which enables the system 20 to accommodate a wide range of conveyor speeds and variations thereof. Typically, however, the imaging capabilities outpace the speed at which the conveyor travels. It will be appreciated that other imaging systems can also be used along with off-board processing capabilities that obtain similar results.

In the exemplary set up shown in FIG. 2, the detection apparatus 30 comprises a personal computer (PC) 40 for interacting with a processing module 42, and a data storage device 48, e.g. a disk drive. The processing module 42 includes smart camera software 44 that is used to take advantage of the Smart Camera's processing capabilities, and a detection program 46 that utilizes the results of the Smart Camera processing to detect scarf 14 in a tube that passes through the detection system 20. Typically, the smart camera software 44 is included in the Smart Camera. However, for clarity, the software 44 is shown schematically as part of the processing module 42. It will be appreciated that the detection apparatus 30 may be located remote from the conveyor 18 rather than being integral to the tube making process and thus the processing module 42 and data store 48 may reside on a network computer (not shown) or any other device that is capable of communicating with the camera 22. As such, it will be understood that the schematic arrangement shown in FIG. 2 is illustrative only and any other suitable arrangement may alternatively be used to achieve similar results.

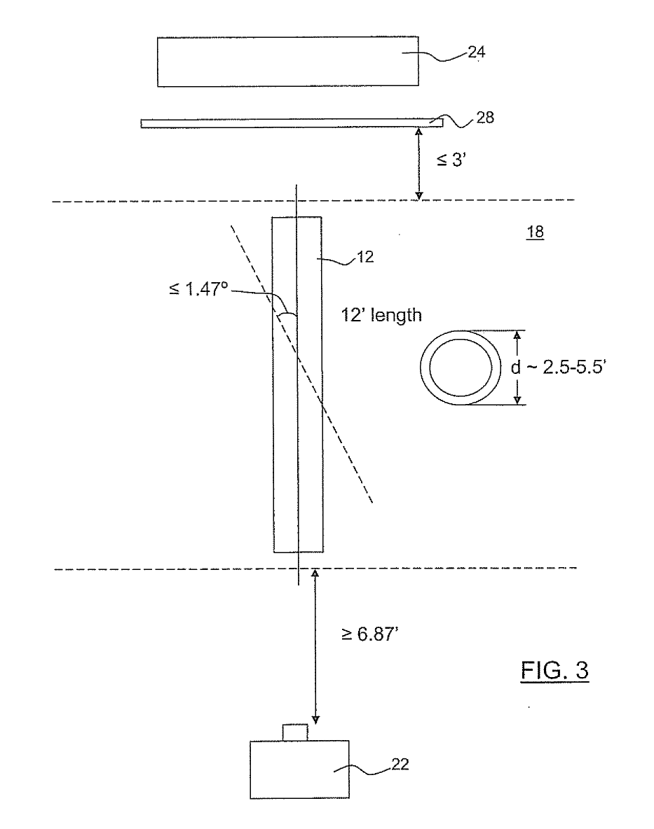

The geometry used is application specific. However, in order to obtain an adequate image of the tube end, basic optics should be considered. For instance, if the camera 22 is too close to the tubes 12 as they pass, the tube end may not fit within the image. On the other hand, if the camera is too far from the conveyor 18 the tube end may appear too small in the image to obtain useful information. An exemplary set up taking the above into consideration is shown in FIG. 3. The tube 12 shown in FIG. 3 is a 12′ long tube and thus the conveyor is sufficiently wide to accommodate such a tube. The tubes 12 described in this example are generally in the range of 2.5″ to 5.5″ in diameter but it will be appreciated that other sizes can be accommodated with the appropriate modifications to the set up shown.

The detection system 20 should be arranged so as to not interfere with the operation of the conveyor 18 and the overall tube making process. However, as shown, a suitable distance between the camera 22 and the tube end is used so that the tube end will fit within the image. It has been found that for tubes in the range of 2.5 to 5.5 inches in diameter, a distance of 6.87 feet or greater is sufficient. Conversely, the illumination system 24 should be close enough to the conveyor 18 to illuminate the tube 12 through to the camera 22 so that the tube end can be obtained in the image with the necessary backlighting to illuminate the scarf 14. It has been found in this example that a distance of 3′ or less is adequate. The diffuser plate 28 should preferably be positioned such that the band of light 26 emitted from the illumination system 24 passes through the plate 28 in its entirety and should not escape around the plate 28.

Although the conveyor 18 is intended to align the tube 12 substantially perpendicular to its direction of travel, there is inevitably some error that may occur which can angularly offset the tube 12 from the perpendicular. It has been found that the geometry shown in FIG. 3 can accommodate up to approximately 1.47° of variation. It will be appreciated that other geometries may accommodate less or even more variation depending on the application.

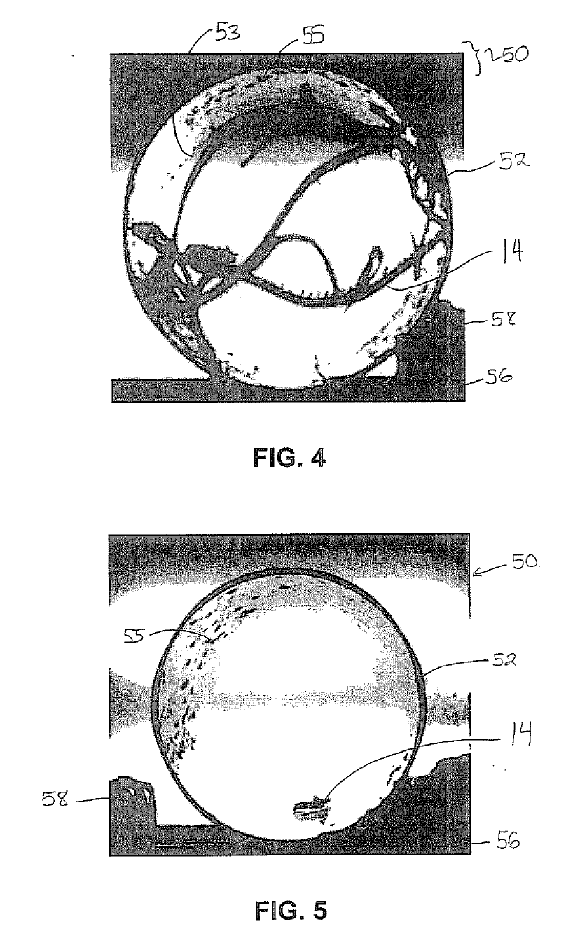

When arranged as shown in FIG. 3, the image 50 obtained by the camera 22 as the tube 12 passes through its field of view should appear as shown in FIG. 4. The image 50 in FIG. 4 includes sufficient backlighting to emphasize the tube outer diameter 52 and the inner diameter 53, as well as the scarf 14 that is lodged in the interior of the tube 12. Also seen in FIG. 4 is a protruding track 58 and a portion the conveyor 56. It is seen from FIG. 4 that the geometry of the system 20 provides a substantial view of the tube end whilst providing suitable backlighting.

Due to the use of the blowout system 10, there are typically a number of water droplets 55 that can be seen in the image 50. These water droplets 55 are usually quite small and thus can be distinguished from the scarf 14. However, in the event that a substantial amount of water has pooled in the tube 12 and the water cannot be distinguished from the scarf 14 by the system 20, a false positive would in fact be preferable since such an amount of water is generally undesirable. Similarly, the detection of other large objects in the image which are not scarf 14 would generally be considered desirable to detect anomalies in the tubular product making process.

As shown in FIG. 5, scarf 14 can vary in size and even small amounts of scarf 14 should be detected by the system 20 without triggering false positives for individual water droplets (or other artefacts) seen on the left interior wall of the tube.

With the proper geometry and sufficient back lighting, the detection system 20 is capable of determining from the image 50, whether or not scarf 14 is present subsequent to the blowout stage A. Where scarf 14 is deemed to be present, a manual inspection can then be triggered by a signal from the system 20. Dark pixels in the image 50 that are inside the outer diameter 52 and possessing a predetermined amount of connectivity (e.g. in a “blob”) are assumed to represent scarf when the percentage of such dark pixels is above a predetermined threshold as will be explained in greater detail below. The presence of scarf, once detected can trigger a manual inspection, a rejection of the tube 12 and the updating of a database for auditing purposes. The data obtained from tube inspection allows an analysis to be made regarding the health of the tube making process, e.g. to determine how often the blowout system 10 fails.

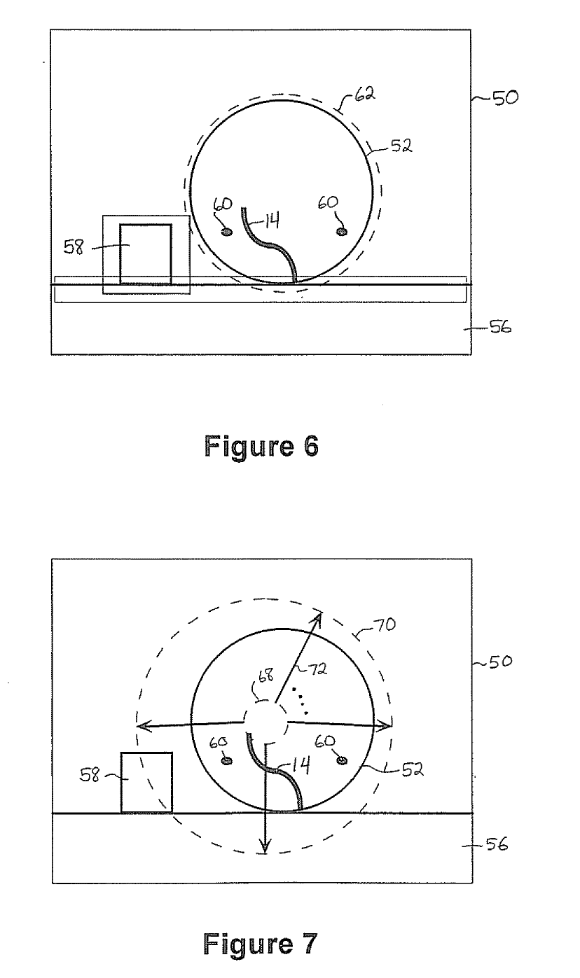

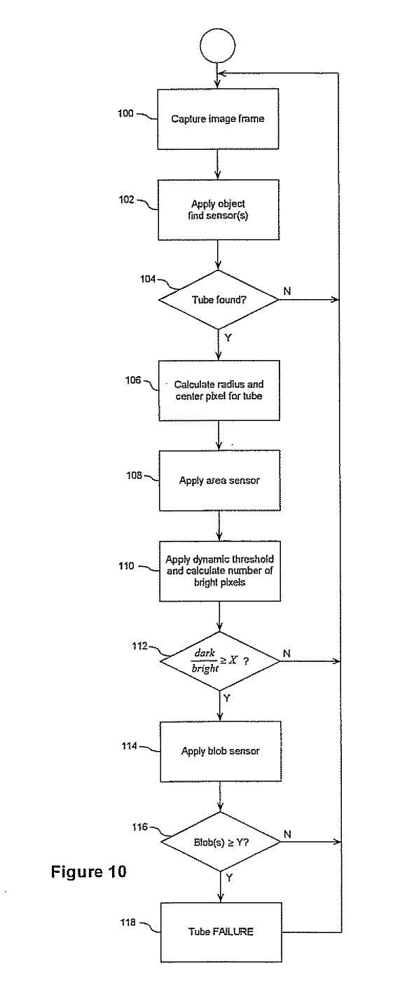

Referring to FIGS. 6 through 11, an exemplary scarf detection process is shown. The processing module 42 is programmed to select images obtained by the camera 22 that include an entire tube end. Turning to FIG. 10, the camera 22 preferably triggers internally at full speed at step 100 (to acquire a new image after every cycle of Image Acquisition Time +Inspection Time dynamically) and uses pre-stored knowledge of what it expects to find, in order to detect the presence of a tube 12. The detection program 46 should only process images 50 that include a tube 12 to increase efficiency. By using a Smart Camera, each image obtained by the camera 22 can be pre-processed to determine which image frames include a tube 12.

The smart camera software 44 (either internal to the camera 22 or being included in the processing module 42) typically includes one or more object find image sensors that can “look” for objects having certain characteristics. In this example, the software 44 learns the characteristics of different tube sizes, e.g. in the range of 2.5″ to 5.5″. The object find sensors are thus calibrated to learn and retain in memory the general outline of the appropriately sized tube silhouettes. In this example, three object find sensors are designated Type 1 for tubes in the range of 2.5″-3.5″, Type 2 for tubes in the range of 3.5″-4.5″, and Type 3 for tubes in the range of 4.5″-5.5″. After each image is obtained, the Smart Camera 22 triggers all object find sensors at step 102. FIG. 6 shows an schematic illustration of an object find sensor 62 that detects tube silhouette 52. The object find sensor 62 identifies edges in the image 50, in particular, those that are connected and appear to form an object. It will be appreciated that the object find sensors are used to take advantage of the Smart Camera's capabilities and, where applicable, a proximity sensor or other apparatus for detecting the presence of a tube 12 could also be used.

Turning back to FIG. 10, at step 104, the software 44 determines if any one of the object find sensors 62 has detected a tube outline 52. If not, the next image frame is processed and steps 100 and 102 are repeated. If one or more of the object find sensors indicates that a tube outline 52 has been found, the image 50 is processed further to detect the presence of scarf.

Since the troublesome scarf is in the interior of the tube 12, the detection program 46 is mostly concerned with the interior of the tube outline 52 in the image 50. In step 106, a circle find image sensor is used to determine the centre and radius of the tube outline 52. As seen in FIG. 7, an inner circle 68 and outer circle 70, which are concentric, are placed in the vicinity of the tube outline 52 such that the inner circle 68 is inside the outline 52 and the outer circle 70 outside. A plurality of vectors 72 (four shown for illustrative purposes only) can then be used to detect edges between the inner circle 68 and outer circle 70. The intersection points of the vectors 72 and the tube outline 52 can then be used to determine where the centre of the tube outline 52 is and to determine the radius. The circles 68 and 70 typically vary depending on which object sensor Type detected the tube 12. However, it will be appreciated that a single circle find sensor may be used so long as it is capable of determining the position of the tube outline 52 in the image.

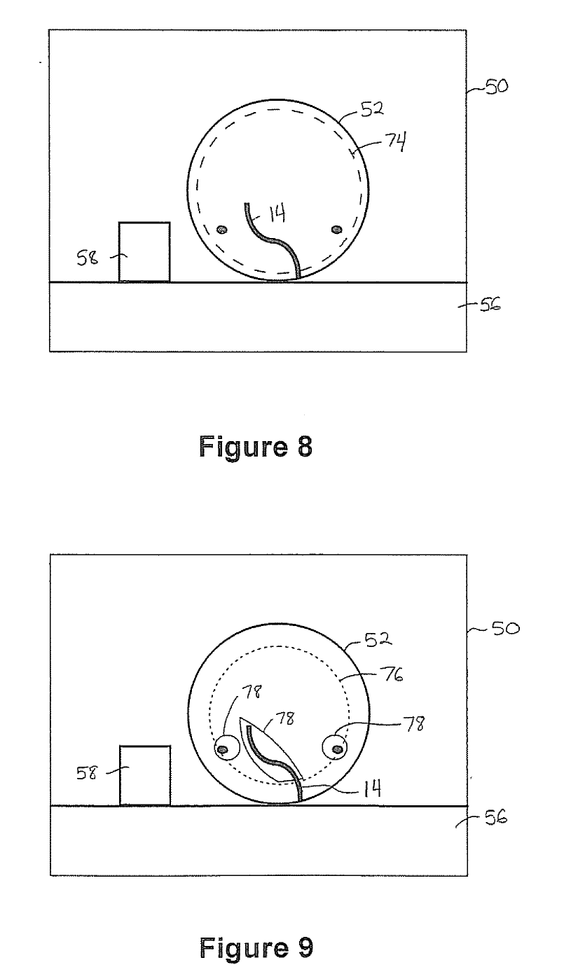

Based on the radius and center of the tube outline 52, an area sensor 74 can be applied at step 108. The area sensor 74 generally comprises the same or similar shape as the expected shape of the tube outline 52. An area sensor 74 is shown in FIG. 8. The area sensor 74 is preferably placed concentric to the tube outline 52 and is smaller in area than the interior of the tube outline 52 in order to avoid considering the tube outline 52 in the detection step. The area sensor 74 applies a dynamic threshold operation at step 110 that calculates the percentage of dark pixels to bright pixels inside the area sensor. As discussed above, since the scarf 14 generally appears in the image 50 as a collection of dark pixels, the greater the percentage of dark pixels, the greater the likelihood of tube scarf 14.

At step 112, the detection program 46 then determines if the ratio of dark pixels to bright pixels is greater than or equal to X, X being a predetermined threshold. If the threshold has not been met or exceeded, then the tube is considered to “PASS” and the next image frame is processed. If the threshold is met or exceeded, then a further processing step is preferably performed to confirm the presence of scarf 14. It has been found that a threshold of X=9% adequately detects scarf 14.

Due to the presence of water droplets and/or other “non-scarf” dark pixels, a blob sensor is preferably applied at step 114 to avoid false positives where the dark pixels are scattered or otherwise do not possess a predetermined level of connectivity. This can occur where a spray of fluid lines the inner wall of the tube 12 causing the percentage of dark pixels to exceed the threshold but where scarf 14 is not present. A blob sensor 78 looks at the connectivity of dark pixels, in particular to determine if a collection of connected dark pixels is of a certain size. As seen in FIG. 9, the blob sensor 78 identifies connected groups of dark pixels within an area 76. The area 76 is preferably smaller than the area sensor 74 in order to accommodate for the pixels that correspond to the inner wall of the tube 12. At step 116, the detection program 46 determines if there are any blobs 78 in the image 50 that meet or exceed a particular threshold Y. If there are no blobs 78 that meet or exceed Y then the tube is considered to “PASS” the tube inspection and the next image frame is processed. If the threshold is met or exceeded in at least one instance, the tube is considered to “FAIL” and a failure command is triggered at step 118.

The threshold Y for the blob detection step 116 is typically application dependent and should be considered based on the geometry and optics used. It has been found in this example that a suitable value for Y is 170 pixels, with a 60% threshold. It is therefore seen that in order for a tube to fail inspection, not only does the percentage of dark pixels in its interior need to be above a threshold, but the blob sensor also should determine that the dark pixels are in fact caused by the presence of material that is scarf 14 rather than water droplets 60.

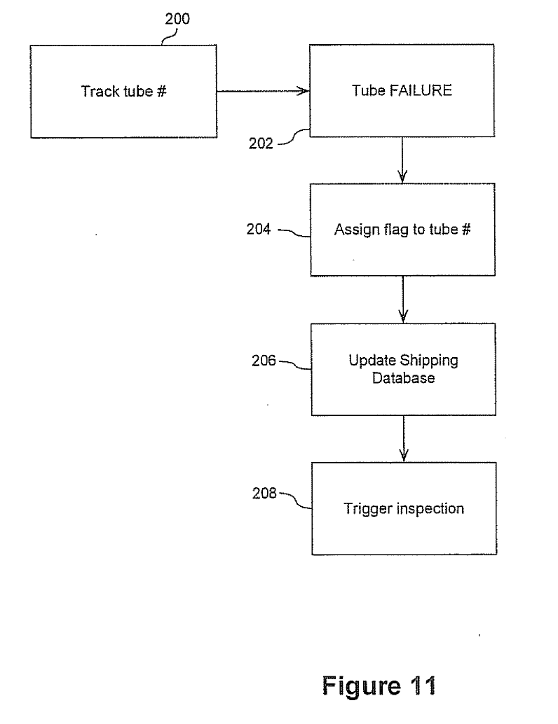

The detection of scarf 14 in the image 50 generates a signal that can be used to remedy the failure prior to shipping. For example, as shown in FIG. 11, each tube that is detected in step 104 can initiate the assignment of a tube number at step 200. At step 202, where a tube failure is realized, a flag can be added to the tube number in the data storage device 48 at step 204. The flag would indicate that the tube has failed inspection. A shipping database could then be updated at step 206 which then triggers a manual inspection/removal of scarf 14 for that particular tube at step 208. Where tubes are loaded into a container in a specified order, the flag and tube number could then be used to pinpoint the exact tube and reduce the manual inspection time. Alternatively, the conveyor 18 could be modified to reject the tube if it fails inspection, e.g. using a trap door or picker. A counter may also be incremented each time a new inspection is performed, which tracks the overall number of passed tubes. The counter value may also be used to track the number of tubes that contain scarf to log the quality and yield of the tubes.

In order to avoid wasted processing, a new inspection should only be performed if the object find sensors transition from a pass to a fail, i.e. from where a tube has been found, to where a tube has not been found. This avoids having the system 20 process the same tube multiple times, due to, e.g., a slow conveyor, a stopped conveyor, etc, where the same tube is in the view of the camera 22 for an extended period of time.

Therefore, it can be seen that the detection system 20 can be used to track the tubes 12 as they prepare for shipping so that scarf information and tube failures are recorded to optimize the manual inspection. The number of tubes 12 that are shipped to the customer with scarf 14 can then be reduced and the need for manual inspection can be reduced or minimized.

It will be appreciated that the above principles apply to tubes of any shape and should not be limited to only circular tubes as exemplified herein. For example, where rectangular tubes (not shown) are being detected, the object find sensor can be calibrated to look for rectangular objects in the image 50. Similarly, the center and radius find would be re-programmed to determine the center of the rectangle as well as the length and width dimensions. Similar principles apply to any shape that is to be detected.

Although the invention has been described with reference to certain specific embodiments, various modifications thereof will be apparent to those skilled in the art without departing from the spirit and scope of the invention as outlined in the claims appended hereto.

1. A method for detecting extraneous material in a tubular product having a first end and a second end comprising:
illuminating said tubular product through said first end;
obtaining an image of said tubular product at said second end; and
processing said image to determine the presence of said extraneous material in the interior of said tubular product.

14. The method according to claim 1 comprising examining said image to determine the presence of said tubular product prior to said processing wherein said processing is only performed if said tubular product is found.

15. The method according to claim 1 wherein said processing comprises applying a first image sensor surrounding said tubular product in said image, applying a second image sensor contained within an outline of said tubular product in said image, and utilizing one or more vectors extending between said first and second image sensors and crossing said outline to determine a centre of said tubular product in said image.

16. The method according to claim 1 wherein said processing comprises applying an area sensor within an outline of said tubular product in said image, said area sensor being used to evaluate pixel brightness within said tubular product for detecting said extraneous material.

17. The method according to claim 4 comprising evaluating pixels within said area sensor and comparing a total number of dark pixels to a total number of bright pixels to determine a percentage, comparing said percentage to a threshold, and if said threshold is met, rejecting said tubular product as having said extraneous material.

18. The method according to claim 1 comprising flagging said tubular product as defective if said processing determines the presence of said extraneous material and triggering an inspection of said tubular product.

19. The method according to claim 1 comprising tracking said tubular product and updating an inventory control system according to said processing.

20. A computer readable medium comprising computer executable instructions for causing a processing module to obtain an image of a tubular product having a first end and a second end, said image being obtained at said first end and said tubular product being illuminated at said second end; and process said image determine the presence of extraneous material in the interior of said tubular product.

21. A system for detecting extraneous material in a tubular product having a first end and a second end comprising:
an illumination system for illuminating said first end of said tubular product;
an imaging system for obtaining an image of said tubular product at said second end; and
a processing module for processing said image to determine the presence of said extraneous material in the interior of said tubular product.

10. The system according to claim 9 wherein said illumination system comprises at least one linear array of light emitting diodes (LEDs).

11. The system according to claim 9 comprising a light diffuser between said illumination system and said first end of said tubular product,

12. The system according to claim 9 comprising an inventory control system, said processing module tracking said tubular product and updating said inventory control system according to said processing.

13. The system according to claim 9 wherein said processing module is located remote from said imaging system.

14. The system according to claim 9comprising examining said image to determine the presence of said tubular product prior to said processing wherein said processing is only performed if said tubular product is found.

15. The system according to claim 9 wherein said processing comprises applying a first image sensor surrounding said tubular product in said image, applying a second image sensor contained within an outline of said tubular product in said image, and utilizing one or more vectors extending between said first and second image sensors and crossing said outline to determine a centre of said tubular product in said image.

16. The system according to claim 9 wherein said processing comprises applying an area sensor within an outline of said tubular product in said image, said area sensor being used to evaluate pixel brightness within said tubular product for detecting said extraneous material.

17. The system according to claim 16 comprising evaluating pixels within said area sensor and comparing a total number of dark pixels to a total number of bright pixels to determine a percentage, comparing said percentage to a threshold, and if said threshold is met, rejecting said tubular product as having said extraneous material.

18. The system according to claim 9 comprising flagging said tubular product as defective if said processing determines the presence of said extraneous material and triggering an inspection of said tubular product.

19. The system according to claim 9 comprising tracking said tubular product and updating an inventory control system according to said processing.

20. The system according to claim 9 wherein said imaging system comprises a Smart Camera.
